(19) United States
(12) Patent Application Publication
(10) Pub. No.: US 2006/0226082 A1
(43) Pub. Date: Oct. 12, 2006

(54) Methods for substrate and modulator screening using enzyme-reactor chromatography/tandem mass spectrometry

(75) Inventors: Michael A. Brook, Ancaster (CA); John D. Brennan, Dundas (CA); Richard Hodgson, Burlington (CA); Travis R. Besanger, Ancaster (CA)

Correspondence Address: BERESKIN AND PARR, 40 KING STREET WEST, BOX 401, TORONTO, ON, M5H 3Y2, CA

(73) Assignee: McMaster University, Hamilton (CA)

(21) Appl. No.: 11/375,054

(22) Filed: Mar. 15, 2006

Related U.S. Application Data
(60) Provisional application No. 60/661,482, filed on Mar. 15, 2005.

(51) Int. Cl. B01D 15/08

(52) U.S. Cl. 210/656; 436/161; 436/171; 435/6; 435/7.1

(57) ABSTRACT

The present invention relates to a method of screening compounds for modulation and binding to proteins, in particular proteins that have been immobilized in a monolithic chromatographic stationary phase. The method involves observing the conversion of a substrate to product by the protein and determining a product to substrate ratio. Changes in this ratio in the presence of another compound indicates that the other compound is a modulator of the enzyme. Various applications of this method to compound screening, including high throughput screening formats, are described.

This application claims the benefit under 35 USC §119(e) from U.S. provisional patent application Ser. No. 60/661,482 filed on Mar. 15, 2005.

### FIELD OF THE INVENTION

The present invention relates to methods for screening compounds for binding to and modulation of proteins, in particular proteins that have been immobilized in monolithic solid supports. Specifically, the present invention utilizes enzyme reactor chromatography in combination with mass spectroscopy to identify and characterize compounds that bind to and modulate proteins.

### BACKGROUND OF THE INVENTION

Rapid screening of enzyme inhibition is the key to the identification of drug leads. The most common methods used for high-throughput screening for enzyme inhibitors involve calorimetric or fluorimetric assays run in multiwell plate format. However, such assays have inherent drawbacks in that: 1) a suitable calorimetric or fluorimetric reagent must be available to generate a signal; 2) interferences can arise from compounds that either absorb or fluoresce at wavelengths similar to the reagent or quench fluorescence; 3) these methods are not amenable to the screening of mixtures; and 4) these methods usually rely upon complex, robotic liquid handling.¹ In cases where spectroscopic assays are not possible, assays are usually done using laborious and time-consuming HPLC-based assays, which are not generally scaleable to high-throughput.

An emerging method that can be used to provide more information on modulation of enzyme function with no need for labels is the monitoring of enzyme catalyzed reactions by mass spectrometry (MS or MS/MS).² Several groups have described studies where enzyme reactions were carried out in wells or other vessels containing the free enzyme, followed by off-line MS analysis of substrates, products and/or inhibitors to evaluate enzyme activity and ligand binding.^{3,4,5,6,7} Other approaches have used immobilized ligands to screen enzymatic activity, with MALDI/MS providing the ability to detect conversion of the ligands.⁸ Still other methods have utilized flow-through reactors wherein both the enzyme and substrate/inhibitor flow through a reaction loop followed by infusion of all components into an ESI/MS system to monitor enzyme activity.⁹ This latter method, while providing the ability to obtain function-based enzyme inhibition data without labels, requires fresh aliquots of enzyme for each analysis, as the enzyme is infused into the MS system.

Protein-doped columns can be used for several potential applications, including: bioselective solid-phase extraction, compound screening based on frontal affinity chromatography, solid-phase biocatalysts for biosynthesis or HTS and evaluation of protein-protein or other protein-based interactions. Current protein-doped columns are based on covalent tethering of proteins to the surface of beads or preformed silica or methacrylate monoliths. However, techniques for the immobilization of proteins on solid surfaces suffer from several limitations including low loading capacities, uncontrolled surface chemistries and difficulty in controlling protein orientation, which can affect protein activity and ultimately separation efficiency. A particular issue with enzyme immobilization on solid supports is the inability to immobilize membrane-associated enzymes, such as the cytochrome P450 family of enzymes. Physical entrapment overcomes these issues, and thus allows for immobilization of a wide variety of proteins (including membrane-associated proteins) without significant activity losses.

Frontal affinity chromatography has recently been hailed as a new method for screening of compound libraries.¹⁰ The basic premise is that when a mixture of compounds is continuously infused into a protein-doped column, compounds that show affinity for the protein will be retained on the column and thus elute later than non-inhibitors. By using tandem MS methods, it is possible to determine the identity of compounds that are retained on the column, even when they are present in mixtures. Furthermore, when combined with a second dimension of LC/MS, it can be used for rapid screening of mixtures containing up to 1000 compounds.¹¹ While this method is one of the few that can directly screen compound mixtures, it is still fraught with potential difficulties related to issues such as non-specific binding to the silica matrix, or binding to non-functional regions of proteins. Furthermore, no information is provided on whether the potential inhibitor actually alters protein function—the only information that is available is a retention time, which ultimately indicates only that the compound bound somewhere in the column. While this can be overcome to some degree by including a second inhibitor of known affinity (a so-called “indicator” compound¹²) into the analyte mixture, there can still be issues related to ion suppression effects that can obscure operation of columns in “roll-up mode”, and the potential to miss allosteric inhibitors if the indicator binds only to the active site. Secondary assays are then required to determine if the compound is actually an inhibitor of the enzyme or receptor.

There are also reports describing the use of immobilized enzyme reactors for examination of enzyme activity and inhibition, although not with on-line MS detection. For example, Wainer and co-workers have reported on the combination of an immobilized enzyme reactor with a reversed phase LC system using absorbance-based detection as a method for examining the activity of immobilized enzymes.¹³ Massolini et al. have developed monolithic columns with covalently bound enzymes to create an immobilized enzyme reactor that was used in conjunction with absorbance detection.¹⁴ Palm and Novotny have used enzyme reactors interfaced with off-line MADLI/MS for evaluation of PNGase F activity.¹⁵ An example of on-line monitoring of an immobilized enzyme reaction by MS was provided by Hindsgaul and co-workers, who used MS to monitor product formation upon introduction of a plug of substrate into an immobilized enzyme column.¹⁶ This method provided a label-free method to assess enzyme activity via MS, but required multiple injections of various levels of substrate and inhibitor to allow construction of a Lineweaver-Burke plot to extract K_{I} values. Additionally, the Gaussian-shaped profiles of the eluted product suggest that enzyme reaction rates do not achieve steady-state equilibrium at the injected substrate concentration.

Because of the very high surface area of a sol-gel material, recently developed biocompatible sol-gel processing methods, and the opportunities for non-covalent encapsulation of both soluble and membrane-associated proteins within a physiologically compatible flow-through sol-gel lattice, columns made of these materials show promise to serve as the basis for the next generation of affinity-based systems. The present inventors have demonstrated the entrapment of a large number of proteins, including labile enzymes such as kinases and luciferase, and membrane-bound proteins such as the acetylcholine receptor and dopamine D2 receptor, and the process and composition of matter related to the monolithic bioaffinity columns has been described in inventor Brennan and Brook's co-pending patent applications entitled “Polyol-Modified Silanes as Precursors for Silica”, PCT patent application publication number WO03/102001, filed on Jun. 2, 2003 and corresponding U.S. patent application publication number US2004-0034203, filed on Jun. 2, 2003; “Methods and Compounds for Controlling the Morphology and Shrinkage of Silica Derived from Polyol-Modified Silanes”, PCT patent application publication number WO 04/018360, filed Aug. 25, 2003, and corresponding U.S. patent application publication number US2004-0249082, filed on Aug. 25, 2003; and “Methods of Immobilizing Membrane-Associated Molecules” U.S. Patent Application Publication No. US-2005-0032246-A, filed on Apr. 2, 2004.

There remains a need for methods of using solid phase immobilized proteins to screen compounds, including libraries of compounds and compound mixtures, for potential modulators as well as binders, said methods being amenable to high throughput screening formats.

### SUMMARY OF THE INVENTION

The present invention relates to a number of new areas for application of protein-doped columns, including: 1) development of a combined FAC/Enzyme Reactor mode, wherein modulators present in compound mixtures are identified both by retention on the enzyme-doped columns (FAC mode) and by alteration of product-to-substrate ratios (functional assay); 2) combining solid phase microextraction (SPME) with FAC/Reactor drug screening to pick out unknown modulators from mixtures (such as natural product mixtures) where modulators are identified by alteration of enzyme function (Product/Substrate, or P/S, ratios), then the column is washed under mild conditions to remove loosely bound compounds, and then a harsh wash bumps the inhibitor to allow direct identification by MS or MS/MS; 3) Development of multi-enzyme (pathway) columns, where all enzymes in a given pathway are entrapped, and modulation of specific points in the pathway by small molecules is detected by monitoring conversion of substrates to products at each stage in the pathway using MS; and 4) development of cytochrome P450 columns for screening of metabolism or toxicity of small molecules (ADME/Tox) based on their ability to act as substrates or modulators of the P450 complex.

The present invention therefore relates to a method for monitoring conversion of a substrate to a product by a protein comprising:

(a) contacting a stream comprising the substrate with a monolithic chromatographic stationary phase comprising the protein immobilized therein under conditions for the substrate to react with the protein to produce the product; and

(b) observing the ratio of product concentration to substrate concentration (P/S) directly or via an indicator of product concentration and an indicator of substrate concentration.

The present invention further involves contacting the substrate with the immobilized protein in the presence of one or more test compounds which may be suspected of having a modulating, for example inhibitory, effect on the activity of the protein. When mixtures of compounds are introduced into the substrate stream, the P/S ratio will remain constant if no modulator is present, but will be altered if a modulator is present. Accordingly, the present invention further relates to a method for screening for modulators of a protein comprising:

(a) contacting a stream comprising a substrate for the protein with a monolithic chromatographic stationary phase comprising the protein immobilized therein under conditions for the substrate to react with the protein to produce a product;

(b) introducing into said stream one or more test compounds; and

(c) observing a change in the ratio of product concentration to substrate concentration (P/S) directly or via an indicator of product concentration and an indicator of substrate concentration, in the presence of the one or more test compounds, wherein a change in P/S in the presence of the one or more test compounds compared to in the absence of the one or more test compounds indicates that at least one of the one or more test compounds is a modulator of the protein.

In an embodiment of the invention, if the P/S ratio is altered in favour of the substrate, then at least one of the one or more test compounds is an inhibitor of the protein. By altering the ratio of the flow between substrate and test compound channels, one can alter the compound concentrations and, thereby, obtain full inhibition curves. When repeated using different substrate concentrations, the K_{I} of the inhibitor(s) can be determined in a single experiment Since substrate and product ions are “separated” by the mass spectrometer, this method eliminates the need for extra dimensions of chromatographic separation, as previously required for enzyme reactor chromatography¹⁷, and greatly increases throughput.

It is an embodiment of the present invention, that the protein is an enzyme. Further the monolithic chromatographic stationary phase may comprise one or more proteins immobilized therein. In yet a further embodiment of the present invention, the concentration or the indicator of the concentration of product and substrate is obtained using mass spectrometry.

In a further embodiment of the invention, once a modulator of a protein is identified by binding to the immobilized enzyme, the column may be washed under conditions to remove unbound, or loosely bound compounds, followed by a second wash under conditions to remove (or bump off) the bound modulator, said modulator then being introduced directly into a mass spectrometer where structural characterization is carried out.

Accordingly, the present invention involves various methods for the screening of compounds that react with proteins entrapped in chromatographic columns. The invention described herein involves the use of monolithic capillary columns containing one or more entrapped proteins, for example enzymes, which can be used for direct determination of substrate turnover or modulation thereof by direct interfacing of the columns to a suitable indicating means or detector. In an embodiment, the columns are operated in frontal mode, involving continuous infusion of analytes, and detection is done by in-line tandem mass spectrometry. The columns can be operated in various modes, as described in more detail below, to allow enzyme-based reactions to be followed by MS in real-time. Various embodiments of the method of the present invention include:
Screening of potential substrates using columns containing a single immobilized enzyme;
Screening of inhibitors using columns containing a single enzyme, suitably by observation of changes in substrate conversion on-column, optionally coupled to retention of potential inhibitors on-column;
Screening of substrate turnover using multi-enzyme columns (where enzymes may optionally be part of a metabolic pathway, or part of a multi-enzyme complex, such as cytochrome P450s);
Multiplexed screening of enzyme inhibition using multiple enzymes immobilized in a single column by observation of changes in specific substrate/product ratios for a particular enzyme on-column;
Toxicity screening using cytochrome P450 columns to assess metabolism of potential substrates or inhibition of substrate turnover using MS to assess substrate to product conversion; and
Determination of inhibitors of unknown structure present in product mixtures using a combined solid-phase extraction/enzyme reactor mode. This mode involves observation of changes in substrate-product ratios to identify the presence of inhibitors, followed by column washing and bump-off steps to elute bound inhibitors directly into a MS for structure elucidation.

In all above embodiments, the use of either monolithic silica or titania columns as a support for immobilized enzymes is included. Further, in all above cases, the use of both electrospray and MALDI MS or MS/MS as detection modes, as well as absorbance or fluorescence detection in cases where one or more analytes is spectroscopically active, is included.

Operation of columns in the above modes will accelerate screening of libraries, both synthetic and natural in origin, against a range of different potential targets. Applications include use of such columns for small molecule screening against kinases, proteases and cytochrome P450s, and for multienzyme (pathway) analysis and combined frontal affinity chromatography/solid-phase extraction/MS (FAC/SPE/MS) analysis of unknown inhibitors in natural product mixtures.

This Summary of Invention lists several embodiments of the invention, and in many cases lists variations and permutations of these embodiments. The Summary is merely exemplary of the numerous and varied embodiments. Mention of one or more specific features of a given embodiment is likewise exemplary. Such embodiment can typically exist with or without the feature(s) mentioned; likewise, those features can be applied to other embodiments of the invention, whether listed in this Summary or not. To avoid excessive repetition, this Summary does not list or suggest all possible combinations of such features.

For purposes of summarizing the invention and the advantages achieved over the prior art, certain objects and advantages of the invention have been described above. Of course, it is to be understood that not necessarily all such objects or advantages may be achieved in accordance with any particular embodiment of the invention. Thus, for example, those skilled in the art will recognize that the invention may be embodied or carried out in a manner that achieves or optimizes one advantage or group of advantages as taught herein without necessarily achieving other objects or advantages as may be taught or suggested herein.

Other features and advantages of the present invention will become apparent from the following detailed description. It should be understood, however, that the detailed description and the specific examples while indicating preferred embodiments of the invention are given by way of illustration only, since various changes and modifications within the spirit and scope of the invention will become apparent to those skilled in the art from this detailed description.

### BRIEF DESCRIPTION OF THE DRAWINGS

The invention will now be described in relation to the drawings in which:

FIG. 1 is a schematic showing an embodiment of the method for inhibitor screening using enzyme reactor chromatography interfaced to mass spectrometry of the present invention. In the embodiment, all mobile phases and samples contain an identical concentration of substrate, while inhibitors are introduced by Pump B, either through an autosampler loop (top) or by loading inhibitors directly into the reservoir for Pump B (bottom). The upper configuration allows for automated screening of multiple compound mixtures while the lower configuration is used for the quantitative analysis of identified inhibitors. Substrate and substrate+inhibitor streams can be infused into the column in any ratio, followed by in-line MS detection. As the concentration of an inhibitor increases, the enzyme within the column is inhibited. Decreased product and increased substrate signals can be used as indicators of enzyme inhibition by unknown test compounds.

FIG. 2 show the MS/MS signal response to increasing analyte concentration for A) adenosine and B) inosine. The non-linear ionization efficiency of electrospray ionization, within the range of analyte concentrations required for the study of adenosine deaminase (ADA), makes instrument calibration for experiments requiring large concentration changes difficult.

FIG. 3 shows calibration data for ADA enzyme reactor column. When total analyte concentration is constant, MRM signal ratios are linear with respect to product:substrate ratios over a relatively broad range.

FIG. 4 shows the results of primary (top) and secondary (bottom) screens of the 49 compounds listed in Table 2. The primary screen indicates that a compound in the mixture containing compounds 36-42 is inhibiting ADA. Deconvolution of the mixture in the secondary screen reveals that EHNA is the inhibitor of ADA. The square injection profiles, shown by the bottom traces in each panel, are programmed by the Eksigent pump and show when the column is exposed to either 500 nM or 10 μM of test compound. The P/S signal ratios show the response of the enzyme to the various test mixtures.

FIG. 5 shows the variation in MS/MS signals for adenosine (substrate) and inosine (product) upon infusion of varying levels of test compounds. Panel A shows infusion of a mixture of fluorescein, folic acid and pyrimethamine according to the programmed infusion profile. Panel B shows infusion of a mixture of fluorescein, folic acid, pyrimethamine and EHNA, with the MS signal from EHNA matching the programmed infusion profile. Adenosine was infused at a constant level of 62.5 μM for both mixture screens.

FIG. 6 shows A) Inhibitor saturation curves obtained by the ER/MS using different concentrations of substrate. The data show the expected decrease in product concentration with increased levels of inhibitor. B) Assessment of Kₘ values for ADA entrapped in a macroporous enzyme-reactor column. The rate of inosine production from the column as a function of the infused concentration of adenosine was determined by multiplying the product concentration data (at [EHNA]=0) in Panel A by the column flowrate. Data are fit to the Michaelis-Menten equation.

FIG. 7 is a graph showing the assessment of Kₘ values for ADA in solution using an absorbance-based assay. Kₘ was determined to be 89 μM.

FIG. 8 shows the effect of EHNA on adenosine deaminase activity was tested at various adenosine concentrations. Panel A shows the normalized saturation curves, which were used to calculate IC₅₀ [EHNA] values by non-linear regression. Panel B shows the use of IC₅₀ values at various adenosine concentrations to access the EHNA:ADA equilibrium constant, K_{I} [EHNA], in the absence of competing substrate, as well as the Michaelis constant, Kₘ, for adenosine:ADA binding.

FIG. 9 shows the reaction catalyzed by Factor Xa.

FIG. 10 shows the effect of 1.0 μM inhibitor (Blaise 3) on substrate and product signals.

### DETAILED DESCRIPTION OF THE INVENTION

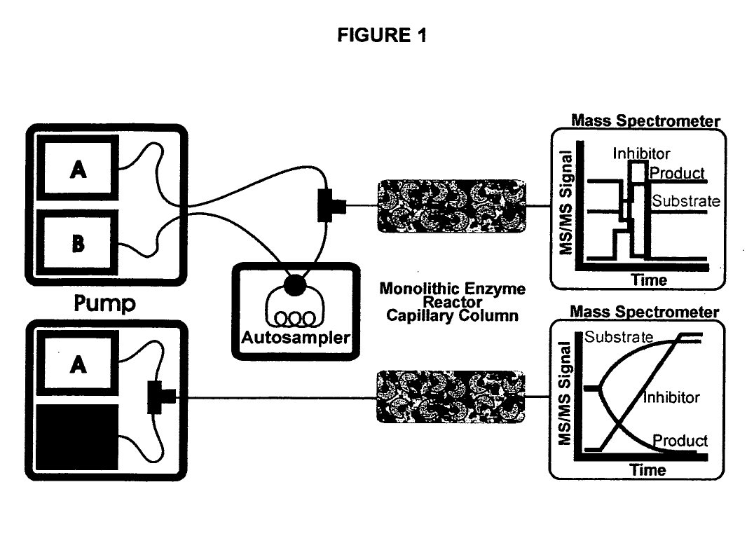

The present invention relates to a new method for protein modulator screening based on the interfacing of enzyme-reactor columns with tandem mass spectrometry (ER/MS/MS). The basic concept is shown in FIG. 1. A substrate is continuously infused into an enzyme-doped column, wherein it is partially converted to product molecules. Using multiple reaction monitoring (MRM) mode, ions specific to the substrate and product are monitored independently to obtain a product-to-substrate (P/S) ratio. Since the sum of S+P is a known constant within the system, the P/S ratio can easily and accurately be used to determine the concentration of the product eluting from the column. When mixtures of compounds are introduced into the substrate stream, the P/S ratio will remain constant if no inhibitor is present, but will be altered in favor of substrate if an inhibitor is present. By altering the ratio of flow between the substrate and substrate/inhibitor channels, one can alter inhibitor concentration in an automated fashion to obtain a multi-compound screen or a full inhibition curve. When repeated using different substrate concentrations, the inhibition constant (K_{I}) can be determined using a single column, saving on reagent costs and assay time. Since substrate and product ions are “separated” by the mass spectrometer, the method of the present invention advantageously eliminates the need for extra dimensions of chromatographic separation as required in previous reports of enzyme reactor chromatography¹⁷ and greatly increases throughput.

The present invention therefore relates to a method for monitoring conversion of a substrate to a product by a protein comprising:

(a) contacting a stream comprising the substrate with a monolithic chromatographic stationary phase comprising the protein immobilized therein under conditions for the substrate to react with the protein to produce the product; and

(b) observing the ratio of product concentration to substrate concentration (P/S) directly or via an indicator of product concentration and an indicator of substrate concentration.

Conditions for the substrate to react with the protein to produce the product will include having the protein immobilized in such a manner that its tertiary structure and accessibility are such that the binding of, and reaction with, molecules that are known substrates or ligands for that protein is permitted.

The present invention further involves contacting the substrate with the immobilized protein in the presence of one or more test compounds which may be suspected of having a modulating, for example inhibitory, effect on the activity of the protein. When mixtures of compounds are introduced into the substrate stream, the P/S ratio will remain constant if no modulator is present, but will be altered if a modulator is present. Accordingly, the present invention further relates to a method for screening for modulators of a protein comprising:

(a) contacting a stream comprising a substrate for the protein with a monolithic chromatographic stationary phase comprising the protein immobilized therein under conditions for the substrate to react with the protein to produce a product;

(b) introducing into said stream one or more test compounds; and

(c) observing a change in the ratio of product concentration to substrate concentration (P/S) directly or via an indicator of product concentration and an indicator of substrate concentration, in the presence of the one or more test compounds, wherein a change in P/S in the presence of the one or more test compounds compared to in the absence of the one or more test compounds indicates that at least one of the one or more test compounds is a modulator of the protein.

In an embodiment of the invention, if the P/S ratio is altered in favour of the substrate, then at least one of the one or more test compounds is an inhibitor of the protein. By altering the ratio of the flow between substrate and test compound channels, one can alter the compound concentrations and, thereby, obtain full inhibition curves. IC₅₀ values are obtained by altering the flow in the substrate and substrate+inhibitor(s) channel in a stepwise fashion, thus allowing for variation of inhibitor concentration with constant substrate concentration. The IC₅₀ value is that concentration of inhibitor at the point where the product concentration is decreased to 50% of its initial value (without the addition of inhibitor(s)). K_{I} values are determined by extrapolation of IC₅₀ values obtained at different substrate concentrations to the point of zero substrate concentration as per the equation:

$$∴ {IC}_{50} = \frac{{K}_{i}}{{K}_{m}} [ S ] + {K}_{i}$$

Hence in a plot of IC₅₀ vs [S], the slope is Kᵢ/Kₘ, the y-intercept is Kᵢ, and the negative x-intercept is −Kₘ. Note that for the enzyme reactor column, product concentration, rather than reaction rate, is monitored. Thus, the equation is valid only under conditions where the initial rate is proportional to product concentration. In the present system, it is assumed that this holds for conversion rates of 30% or less.

In a further embodiment of the invention, once a modulator of a protein is identified by binding to the immobilized enzyme, the column may be washed under conditions to remove unbound, or loosely bound compounds, followed by a second wash under conditions to remove (or bump off) the bound modulator, said modulator then being introduced directly into a mass spectrometer where structural characterization is carried out.

The monolithic chromatographic column may be, for example, any siliceous material that is compatible with the immobilization of proteins. By “compatible” it means that the conditions for the preparation, storage and use of the protein-immobilized material do not lead to denaturation and therefore loss of activity of the protein. In an embodiment of the invention, the protein-compatible matrix is a sol gel prepared using biomolecule-compatible techniques, i.e. the preparation involves biomolecule-compatible precursors and reaction conditions that are biomolecule-compatible. In a further embodiment of the invention, the biomolecule-compatible sol gel is prepared from a sodium silicate precursor solution. In still further embodiments, the sol gel is prepared from organic polyol silane precursors. Examples of the preparation of biomolecule-compatible sol gels from organic polyol silane precursors are described in inventor Brennan and Brook's co-pending patent applications entitled “Polyol-Modified Silanes as Precursors for Silica”, PCT patent application publication number WO03/102001, filed on Jun. 2, 2003 and corresponding U.S. patent application publication number US2004-0034203, filed on Jun. 2, 2003; and “Methods and Compounds for Controlling the Morphology and Shrinkage of Silica Derived from Polyol-Modified Silanes”, PCT patent application publication number WO 04/018360, filed Aug. 25, 2003, and corresponding U.S. patent application publication number US2004-0249082, filed on Aug. 25, 2003.

In addition to silica columns, entrapment of enzymes may also be done in either titania or methylsilsesquioxane (MSQ) columns that contain a mixture of macro and mesopores. The titania columns provide advantages in terms of pH ranges of eluents that can be passed through the column, while the MSQ columns may be useful for entrapment of hydrophobic enzymes such as lipases of cytochrome P450s.

In an embodiment of the invention, the monolithic chromatographic stationary phase is housed in a capillary column.

In another embodiment of the invention, the indicator of product and substrate concentration is the intensity of a characteristic molecular ion signal obtained from an “in-line” or “off-line” mass spectrometer. Known concentrations of substrate and inhibitor can be injected into the mass spectrometer and the corresponding intensities of the characteristic molecular ion peak for the compound(s) can be used to generate calibration curves for the system being studied. In an embodiment of the invention the mass spectrometer is operated in positive ion or negative ion electrospray ionization (ESI) mode. Further, mass spectral detection may be carried out in multiple reaction monitoring mode which allows the simultaneous monitoring of several molecular ions, and thus allows the possibility of monitoring more than one substrate/product pair.

In addition to the LC/ESI/MS and FAC/ESI/MS studies described herein, the enzyme reactor columns may also be interfaced to MALDI MS/MS. In this embodiment of the invention, deposition is done from the column directly onto a MALDI plate using any one of several established MALDI deposition methods, and the plates are read using either MALDI quadrupole:TOF or MALDI triple quadrupole or quadrupole:ion trap MS/MS systems, which are well suited to analysis of low molecular weight compounds. MALDI detection will allow for use of much higher ionic strength buffers for elution, which will keep entrapped proteins more active. A particular advantage of MALDI detection is that, once the track is deposited, multiple modes of MALDI/MS can be run (positive or negative mode, Q1 scans, product ion scans, precursor ion scans, etc) to first identify and then quantitate compounds that are present on the plate (a task that is much more difficult to do using ESI/MS since one must switch modes on-the-fly while the compounds are eluting). Use of MALDI will be particularly important when using membrane-associated proteins in columns, since low ionic strength, which is required for ESI/MS, will likely cause significant denaturation of membrane proteins. Retention of activity for membrane proteins often requires relatively complex buffer systems with specific additives, such as EDTA, and divalent metals, such as Mg(II), which would likely be deleterious to direct ESI/MS analysis. Such compounds can be removed from the MALDI plate prior to analysis, or MRM transitions can be found that reduce or eliminate the effects of such species when using MALDI/MS.

For multiplexed ER/MALDI a bank of 4-8 sprayers introduces samples onto the 4-8 MALDI plates simultaneously using a single 8-channel Eksigent nanoflow LC system. By using enhanced flow-rates and parallel columns as proposed herein, the throughput is easily enhanced further by at least one order of magnitude over conventional LC/MS. For example, connecting the MALDI deposition system with 8 monolithic columns simultaneously permits an 8-fold increase in throughput as compared to conventional LC/MS. Together with elevated flow-rates and shorter column equilibration periods for monolithic capillary columns relative to bead-based columns, a 30 to 40-fold time enhancement of throughput is easily achievable.

A high-throughput multiplexed sprayer system for parallel sample introduction has been developed for use with capillary monolithic columns.¹⁸ The system includes a multichannel HPLC capillary pump unit (Eksigent 8 channel pump); a multi-injector interface; the column cluster of 4 to 8 columns; and a multiplex spray interface between the columns and the MALDI plate. The columns will be operated in the 0.05 to 10 μL/min flow rate range.

In some cases detection of substrate to product conversion (or inhibition thereof) can also be detected using either absorbance or fluorescence detection, particularly in cases where chromogenic or fluorogenic substrates are available.

The protein(s) used in the methods of the present invention may be any protein for which one wishes to investigate interactions with a substrate. In an embodiment of the invention the protein is an enzyme which is involved in the conversion of a substrate to a particular product. In further embodiments of the invention, the conversion of the substrate to a product is relevant to a biological process, the modulation of which is associated with, for example, one or more diseases. Non-limiting examples of proteins that may be used in the methods of the present invention are: kinases, receptor tyrosine kinases (e.g., epidermal growth factor receptor, whole or kinase domain only), proteases, hydrolases, lipases, oxidases, reductases, phosphatases, esterases, nucleases, ligases, transciptases (e.g., HIV-reverse transcriptase). Proteins may be soluble or membrane bound, may be intrinsic or extrinsic to a lipid membrane, may be natural or recombinant, and may comprise the whole enzyme or only a catalytic subunit. Furthermore, a series of proteins that work together to catalyze a coupled reaction (e.g., choline oxidase/horeradish peroxidase or cytochrome P450 complexes) may be utilized. Specific, non-limiting examples of proteins may include: adenosine deaminase, glycogen sythase kinase 3, protein kinase A, Factor Xa, urease, g-glutamyl transpeptidase, phospholipase A2, monoamine oxygenase A or B, dihydrofolate reductase, alkaline phosphatase, acetylcholine esterase, DNAse I or T4 ligase. A person skilled in the art would appreciate that the protein(s) must be compatible with the chromatographic and detection conditions that are available for use in the methods of the present invention.

The one or more test compounds can be any compound(s) which one wishes to test including, but not limited to, proteins (including antibodies), peptides, nucleic acids (including RNA, DNA, antisense oligonucleotide, peptide nucleic acids, RNA or DNA aptamers, ribozymes or deoxyribozymes), fragments of proteins, peptides, and nucleic acids carbohydrates, organic compounds, inorganic compounds, natural products, library extracts, bodily fluids and other samples that one wishes to test for modulation of the protein. A person skilled in the art would appreciate that the test compound(s) must be compatible with the chromatographic and detection conditions that are available for use in the methods of the present invention.

To assess the enzyme-reactor chromatography/tandem MS method for inhibitor screening, monolithic silica columns containing entrapped adenosine deaminase (ADA, EC 3.5.4.4) and Factor Xa were formed according to previously described methods.²⁵ ADA was used as the model enzyme owing to the relevance of this protein in immune disorders,¹⁹ and because there are currently no high-throughput screening methods for this enzyme. An Eksigent nanoLC system was used to continuously infuse liquid through the column (10 μL/min total flowrate), with one channel containing adenosine (Pump A) and another containing adenosine plus 1 μM test compound(s) (Pump B), with all species present in 2 mM ammonium acetate buffer (FIG. 1, bottom). MRM transitions corresponding to adenosine (substrate, m/z 268→169), inosine (product, m/z 267→168) and various test compounds were monitored as the concentration of the test compound(s) was increased by altering the ratio of flow rates from pumps A and B.

The concentrations of test compounds were increased in a stepwise fashion from 0 nM to 1000 nM. Fluorescein, folic acid and pyramethamine have no effect on the activity of ADA, as expected. However, when erythro-9-(2-hydroxy-3-nonyl)adenine (EHNA) was included in the mixture a clear, concentration-dependent decrease in ADA activity, as determined by a reduction in P/S ratios, was apparent.

It should be noted that adenosine and inosine differ in mass by only one mass unit (m/z 268 vs. 269), and thus isotope effects exist wherein the adenosine substrate will show some signal at m/z 269 even if inosine is completely absent. Calibration data show that there is still ˜5% signal overlap when using MRM transitions. This situation will occasionally effect monitoring of enzyme catalyzed reactions but calibration can eliminate this issue.

To relate the substrate and product signals to concentrations, a variety of substrate and product ratios were infused directly into the mass spectrometer to obtain a curve relating signal ratio to concentration. P/S signal ratios, at constant total concentrations, were used for calibration to minimize artifacts of ion suppression. Calibration data for adenosine and inosine, with total infusion concentrations between 25 and 300 μM (adenosine+inosine), indicate the signal ratio is linear with respect to the P/S concentration ratio, up to a minimum of 4:1, and indeed a working range from 0:1 up to 10:1 P/S was obtainable. Data obtained in this manner are analogous to a series of endpoint assays. It is assumed that the product concentration is proportional to initial reaction rate for this method to be valid. However, flow rate and column length can easily be adjusted to suit more or less active enzymes.

Changes in enzyme activity as a function of inhibitor concentration can be used to determine IC₅₀, K_{I} and Kₘ values. Fitting to a simple ligand binding isotherm provides IC₅₀ values. The nearly identical IC₅₀ values obtained for EHNA in a mixture (29.7 nM) and alone (29.4 nM) indicate the usefulness and validity of this technique for mixture screening. A novel form Cheng and Prusoff's equation²⁰ allows extrapolation of the IC₅₀ values to provide the K_{I} [EHNA] and Kₘ for the substrate. The resulting K_{I} of 15.7±3.5 nM is in reasonable agreement with the published K_{I} value of 6.5 nM.²¹ The Kₘ value of 124±42 μM also matches with values obtained from absorbance assays (89 μM)²² and enzyme reactor/MS assays (106 μM).

It should be noted that the IC₅₀ data obtained using the enzyme reactor column method required only 2 h, and all data in this study were obtained using a single, re-usable enzyme reactor column. The internal control offered by this method is unprecedented and a significant improvement over existing analytical methods. The determination of the IC₅₀ value using a conventional HPLC method²³ required close to 2 days to obtain, and absorbance based assays²¹ were inaccurate due to substantial spectral overlap of EHNA absorbance with that of adenosine. Furthermore, both methods required a separate enzyme aliquot for each measurement, increasing assay cost.

Advantages of the enzyme-reactor/MS method for direct screening of enzyme inhibitors include rapid functional screening of enzyme activity and inhibition with no chromogenic or fluorogenic substates and no co-factors; use of tandem MS for assessing product:substrate ratios, which is highly versatile, and amenable to virtually all enzymatic reactions; the ability to screening mixtures; the ability to run multiple assays using a single, re-useable column; and the potential to identify unknown inhibitors using the enzyme reactor method in conjunction with MS detection.

In another embodiment the present invention, inhibitors can be screened in the presence of non-inhibitors by a combination of both retention on the column (FAC mode) and alteration of S/P ratios (reactor mode). By combining FAC and reactor modes, it is easier to evaluate which of the compounds in a mixture is the actual inhibitor. For these studies, mixtures of known compounds, suitably containing 2-20 compounds per mixture and the substrate for the enzyme, are tested using multiple reaction monitoring (MRM) mode to simultaneously monitor substrate, product and each potential inhibitor compound. Substrate is first infused in channel 1 of a multichannel LC pump to establish a “baseline” S/P ratio. Then, a second channel containing an identical amount of substrate and ˜10 μM of each compound is mixed with channel 1 in different proportions to cause a slow increase in compound concentration, while retaining a constant substrate concentration. If the mixture contains an inhibitor, there will be an increase in S/P ratios as the compound concentration rises. By using a step gradient of the compound mixture, IC₅₀ data is obtained, and along with the identity of which compound is the inhibitor based on it having a lag-time for elution relative to the non-inhibitors (tested either with or without substrate present).

In yet another embodiment, the present invention involves extending the FAC/reactor mode, outlined above, to the screening of mixtures of unknown compounds, such as natural product mixtures. In this mode, unknown inhibitors can first be detected by monitoring alterations in S/P ratios in the presence of the compound mixture (which indicates that something in the mixture is an inhibitor), and a “wash and bump” step is done to allow the tightly bound inhibitor to be first captured on the column, and then bumped off and identified directly by MS or MS/MS using Q1 scans or product ions scans.

Operation in the combined Solid Phase Extraction (SPE)/FAC/Reactor is done as follows. Using a four-channel pump, the experiment begins by pumping in a mixture of compounds where one of the compounds is a relatively potent inhibitor (sub μM). Running substrate in one channel and substrate+mixture in the other, ONLY the substrate/product ratio is monitored in the first instance to determine that there is in fact an inhibitor in the mixture. A third channel containing a mild wash solution with no substrate or inhibitors present is used to remove substrate, product and unbound compounds. This step is monitored directly by using the MS to follow the loss of the substrate or product with time. As soon as the substrate signal approaches zero, a fourth channel is used to introduce a harsh washing solution (such as 80% MeOH) to achieve a good electrospray and, more importantly, to bump off whatever is bound to the protein on the column. During elution a full spectrum is collected in Q1 (a Q3 scan can also be obtained using peak parking during the bump off step). In this way full MS data is obtained to characterize the structure of the inhibitor, and by doing the bump off, it is possible to obtain a concentration enhancement that will improve the signal to noise level.

In a further embodiment of the present invention, the enzyme reactor is operated in multi-enzyme (pathway) mode. This mode of operation is utilized for two separate screening methods. The simplest use of this mode is to extend the throughput of compound screening by creating columns that contain a series of enzymes which are NOT in the same pathway. For example, a column containing three enzymes could be prepared, and would allow examination of substrate conversion for each of the three enzymes simultaneously by infusing all three substrates at once in channel 1 of the pump and using the MS operated in MRM mode for detection of individual substrate/product ratios. Introduction of compound mixtures (along with the three substrates) in channel 2, where the mixture may contain inhibitors to one or more of the enzymes, will lead to alterations in the S/P ratio of the specific enzyme that the compound targets. In this way, the biological target of the compound is identified. Identification of the compound itself could be done either using FAC mode (if the compound structure is known), or using the SPME method outlined above if the structure is unknown.

A second mode of operation in the multiple enzyme column is to use multiple enzymes that are all part of the same pathway. Coupled reactions involving 2 or more enzymes (part of a pathway) can be entrapped together in a single column (or, alternatively, individual single-enzyme columns could be generated and coupled together in series). The substrate for enzyme 1, plus any reactants or cofactors needed for the second or third enzymatic steps, would then be introduced into the column. Substrate 1, product 1 (which is also substrate 2), product 2 (substrate 3), and product 3 would all be monitored simultaneously to determine how far along a pathway a particular coupled reaction proceeds. In cases where conversion to the final product does not occur, it will be possible to determine which enzyme is targeted by monitoring changes in all S/P ratios. Such systems will provide new tools for either increasing the information content of a single screen by using multiple targets and inhibitors simultaneously, or will allow for screening of pathways with direct MS detection.

A yet another embodiment of the present invention involves enzyme reactors comprising cytochrome P450 enzymes for ADME/Tox studies. A major part of the drug discovery process is identification of potential side-effects of drugs. At this point, most pharmaceutical companies have libraries of several million compounds, which are routinely screened against particular targets. Once the primary screening has identified potential leads, it then necessary to test the metabolism and toxicity of the compounds, usually using a suite of cytochrome P450 systems isolated from the liver. In cases where the compound is either a substrate or an inhibitor of the P450 system, it can no longer be used for drug development.

One problem in drug discovery using libraries of compounds is that a large fraction of compounds in the library may interact with P450 systems, and thus these compounds are screened multiple times against multiple targets, and will not be identified unless they show some activity, and are then subjected to ADME/Tox studies. Ideally, one could screen the toxicity of the library first, and then discard those compounds that show interactions with P450s, and never have to screen them again. However, assaying of P450 function is a slow, laborious process that currently involves time-consuming HPLC methods, and development of calorimetric and fluorimetric assay methods for P450s is not generally viable, since in many cases the goal is to identify substrates, which are not inherently chromophoric. Thus, high throughput screening of compounds against P450s is not yet possible. As described in this invention, this situation can be addressed by entrapping P450 complexes into monolithic silica columns, which allow for a direct enzyme reactor/LC/MS mode to screen for both substrates and inhibitors of P450s.

Columns are created that contain any one or more of several different cytochrome P450 systems. Such columns can be infused with both substrates and inhibitors, the conversion (or inhibition of conversion) of which can be detected by MS/MS analysis. These studies allow for the study of not only substrate conversion, as noted above, but also inhibition of substrate conversion upon infusion of compound mixtures. This can be run using the combined FAC/reactor mode noted above, or alternatively, the SPE/FAC/reactor mode. Conversion of compounds into secondary products (i.e., identification of potential substrates of P450s) is also possible.

In cases where the activity of an entrapped enzyme is inherently low, it may be the case that substantial turnover of substrate is not possible when using continuous infusion of substrates, as described above. In such cases, it is possible to operate any of the assays outlined above using a stopped flow mode of operation. In this case, the substrate (and inhibitor) would be injected onto the column and allowed to incubate with the entrapped enzyme for a specific period of time. Following incubation, the column contents can be eluted directly into the mass spectrometer where product to substrate ratios will be monitored, either as a function of substrate type or concentration, or of inhibitor type or concentration.

As used herein, the terms “comprises”, “comprising”, “including” and “includes” are to be construed as being inclusive and open ended, and not exclusive. Specifically, when used in this specification including claims, the terms “comprises”, “comprising”, “including” and “includes” and variations thereof mean the specified features, steps or components are included. These terms are not to be interpreted to exclude the presence of other features, steps or components.

The following non-limiting examples are illustrative of the present invention:

### EXAMPLES

### Example 1

### Adenosine Deaminase Enzyme Reactor/MS

Materials

Ammonium acetate and HPLC grade water were purchased from Caledon Laboratory Chemicals (Georgetown, Ontario, Canada). EHNA (erythro-9-(2-hydroxy-3-nonyl)adenine) was purchased from Calbiochem (San Diego, Calif., U.S.A., cat# 324630). Diglycerylsilane (DGS) was prepared by methods described elsewhere²⁴ using tetramethylorthosilicate (Sigma-Aldrich) and anhydrous glycerol (Fisher Scientific). Adenosine deaminase (ADA, Type V, from bovine intestine, EC 3.5.4.4), adenosine, inosine, 2-fluoro-2′-deoxyadenosine, folic acid, pyrimethamine, fluorescein, 10 kDa poly(ethylene glycol) and bis-tris buffer salt were obtained from Sigma-Aldrich (Oakville, Ontario, Canada). Other compounds used for the primary screening experiment are listed in the supplementary data section. Fused silica tubing was purchased from Polymicro Technologies (Phoenix, Ariz., U.S.). Distilled deionized water was obtained from a Milli-Q Synthesis A10 water purification system. All reagents were used as received.

Fabrication of ADA Columns

Columns were fabricated in a fashion similar to that described previously.²⁵ ADA was exhaustively dialyzed against a solution containing 5 mM Bis-Tris.HCl, pH 6.5, with 10% (v/v) glycerol to remove all traces of phosphate buffer and adjust the pH. 40 mL of the resultant 40 mM ADA solution was then mixed with 20 mL of a solution containing 0.5 mM Bis-Tris.HCl, pH 6.5 with 50% (v/v) glycerol. DGS based sols were prepared by sonicating DGS with water (1 g+1 mL) at 0° C. for 15 min to hydrolyze the monomer, followed by filtration through a 0.2 mm filter. 100 mL of the resulting sol was rapidly mixed with the 60 mL ADA solution prepared above, followed by the rapid addition of 40 mL of 40% (w/v) poly(ethylene glycol) in water. The sol solution was then injected into an 80 cm length of 250 mm i.d., 360 mm o.d., polyimide coated fused silica tubing that was previously cleaned using 1 M NaOH. The liquid sol must be completely mixed, injected and stationary within the capillary by the time phase separation occurs, ˜2 minutes after mixing. After gelation (˜3 min), capillaries were looped such that both ends could be submerged in 50 mM Bis-Tris.HCl pH 6.5 and secured for storage. Columns were aged for a minimum of 5 days to achieve a relatively stable internal structure. After aging, 10 cm column segments were cut from poured columns, as required.

LC/MS Settings

A 2 channel, Eksigent nanoLC pump was used for mobile phase delivery to a MDS Sciex Q-Trap Mass Spectrometer. Note that the Eksigent pump uses direct pneumatic pumping of mobile phase at μL/min rates, with no flow splitting. An Eksigent AS-1 48 vial autosampler was fitted with a 250 μL withdrawal syringe and a 150 μL loop of 250 μm i.d. fused silica tubing. Thus, only small volumes of inhibitor solutions (˜400 μL) are required for screening, although larger volumes can be loaded directly into the Eksigent pump reservoir (1-5 mL depending on configuration) for determination of IC₅₀ values. Mobile phase delivery was controlled by Eksigent nanoLC software v 2.05. Mobile phases were run directly into the MS system, without the introduction of an organic “make-up flow”. Mass spectrometer control and data acquisition was done using Analyst v.1.4 software. Precursor-product ion pairs were followed using multiple reaction monitoring (MRM) mode in positive ion mode under the following conditions: Curtain Gas=30.0, Collision gas=medium, Ion Spray Voltage=5500 V, Temperature=140° C., Ion Source Gas 1=40.0, Ion Source Gas 2=40.0. Specific MS/MS parameters for each ion pair are provided in the supplementary data section (Table 1). The total scan time was 2 seconds per point.

Column Handling

Prior to experiments, a fresh 10 cm column segment (5 mL internal volume) was equilibrated off-line, with mobile phase from Channel A, to remove aqueous poly(ethylene glycol) and glycerol. New columns were connected to the pump using 75 mm i.d. fused silica tubing and another 75 mm i.d. tubing segment was attached to the bottom of the column using Upchurch Microtight unions (Oak Harbor, Wash., U.S., P. 772). Several bed volumes of mobile phase were passed through the column at 0.5 mL/min before slowly increasing the flow rate to 12 mL/min, and finally back to 10 mL/min, for experiments. Columns were attached directly to the Turbospray ion source of an MDS Sciex Q-Trap mass spectrometer with 75 mm i.d. fused silica tubing. When exchanging mobile phases within the pumps, the column was removed from the system and connected top to bottom with a buffer filled capillary. The column fittings were not adjusted or removed from the column after the initial washing step.

Mixture Screening

Compound mixtures were screened using the autosampler system configuration shown in FIG. 1 (top). In this system, the flow from Channel A bypasses the autosampler and enters a pre-column mixing Tee, while the flow from channel B is directed through the autosampler loop to introduce compound mixtures into the mixing Tee prior to passing through the enzyme reactor column. A total of 49 biochemical compounds were selected for screening and were dissolved in DMSO to a concentration of 10 mM. For the primary screen, compounds were mixed into seven groups of 7 compounds each (see Table 2 for a list of the compounds tested) and diluted to 10 mM in aqueous 2 mM ammonium acetate buffer containing 200 mM adenosine. Mobile phase, loaded into channels A and B of the Eksigent pumps, contained 2 mM ammonium acetate, 200 mM adenosine and a DMSO concentration to match the samples (0.7% v/v). The DMSO was included to mimic the solvent composition that would be present in a standard compound library. After suitable column equilibration (see above), sample mixtures were infused from the autosampler loop at 5% and 100% of total flow (based on the ratio of flowrates in channel B relative to channel A) with a total flowrate of 10 mL/min. Under these conditions, the column-entrapped enzyme was exposed to 500 nM, followed by 10 mM of each compound in each mixture. The step profile (see FIG. 1, top) was set such that the pre-equilibration step and post-equilibration step (no inhibitor) were each 20 min in duration while exposure to low and high inhibitor concentrations were for 10 minutes each. In this manner, less than 150 mL of inhibitor solution was used for each 2 point screen.

Secondary screening was performed on each of the 7 compounds in the active mixture identified by the primary screen. Each compound was individually diluted to 10 μM in 2 mM ammonium acetate plus 200 μM adenosine. The DMSO concentration in the mobile phase was adjusted accordingly (0.1% v/v) and injection was performed as described above, using the same time steps.

Determination of IC₅₀ and K_{I} Values

An alternative pump configuration, shown in FIG. 1 (bottom), was used for quantitative determination of inhibition constants. An adenosine solution (62.5, 125, 250 or 500 μM) in 2 mM ammonium acetate buffer was loaded into Channel A of the Eksigent nanoLC pump. Channel B was loaded with a solution containing an identical adenosine concentration plus a mixture containing 1 μM of each test compound (fluorescein, pyrimethamine, folic acid and EHNA (absent in control)).

The MS system was calibrated as described below to provide a means to determine product:substrate ratios from the ratio of intensities for ion pairs related to adenosine (substrate, m/z 268→m/z 136) and inosine (product, m/z 269→m/z 137). IC₅₀ values were obtained by altering the ratio of flow in the substrate and substrate+inhibitor channels in a stepwise fashion while maintaining a combined flow rate of 10 μL/min.

In this manner, the inhibitor concentration could be varied while maintaining a constant substrate concentration. In the programmed infusion profile, each mobile phase ratio remained constant for 10 minutes to allow for an equilibrium condition to be achieved within the column. Data collected from a 7 minute window, corresponding to the center of each 10 minute equilibrium state, were averaged to give each data point. Substrate and product ion pairs were monitored once every 2 seconds so each data point was determined from 420 individual MRM measurements. The raw data was used to calculate a product/substrate ratio, from which the concentration of product eluting from the column was ultimately determined. This value was normalized by letting the maximum product concentration in the absence of inhibitor correspond to a relative activity 100%. IC₅₀ values were obtained from the point where the relative activity decreased to 50% of its initial value.

The K_{I} value was determined by extrapolation of IC₅₀ values to the point of zero substrate concentration. The method is based on the derivation described by Cheng and Prusoff,²⁶ as shown below. Kₘ values were obtained using immobilized enzyme reactor columns by plotting the concentration of product formed upon infusion of a given concentration of substrate and fitting the data to the Michaelis-Menten equation. The data was compared to that obtained using a conventional absorbance based assay (see below).²⁷

The Michaelis-Menten equation is given by:

$${V}_{o} = \frac{{V}_{max} [ S ]}{{K}_{m} + [ S ]}$$

where V₀ is the initial rate of the enzyme catalyzed reaction. In the presence of a competitive inhibitor with an inhibition constant K_{I} and a concentration [I], the rate of reaction will be reduced to V_{I}:

$${V}_{I} = \frac{{V}_{max} [ S ]}{{K}_{m} ( 1 + \frac{[ I ]}{{K}_{i}} ) + [ S ]}$$

By definition, if [I] is equal to IC₅₀ then V_{I}=½Vₒ and hence:

$$\frac{{V}_{max} [ S ]}{{K}_{m} + [ S ]} = \frac{2 {V}_{max} [ S ]}{{K}_{m} ( 1 + \frac{{IC}_{50}}{{K}_{i}} ) + [ S ]}$$

Rearranging and solving for IC₅₀:

$$\frac{1}{{K}_{m} + [ S ]} = \frac{2}{{K}_{m} ( 1 + \frac{{IC}_{50}}{{K}_{i}} ) + [ S ]} \\ ∴ {K}_{m} ( 1 + \frac{{IC}_{50}}{{K}_{i}} ) + [ S ] = 2 {K}_{m} + 2 [ S ] \\ ∴ {K}_{m} ( 1 + \frac{{IC}_{50}}{{K}_{i}} ) = 2 {K}_{m} + [ S ] \\ ∴ 1 + \frac{{IC}_{50}}{{K}_{i}} = 2 + \frac{[ S ]}{{K}_{m}} \\ ∴ \frac{{IC}_{50}}{{K}_{i}} = 1 + \frac{[ S ]}{{K}_{m}} \\ ∴ {IC}_{50} = {K}_{i} ( 1 + \frac{[ S ]}{{K}_{m}} )$$

Rearranged in the form of a linear equation:

$${IC}_{50} = {K}_{i} + \frac{{K}_{i} [ S ]}{{K}_{m}} \\ ∴ {IC}_{50} = \frac{{K}_{i}}{{K}_{m}} [ S ] + {K}_{i}$$

Hence in a plot of IC₅₀ vs [S], the slope is Kᵢ/Kₘ, the y-intercept is Kᵢ, and the negative x-intercept is −Kₘ. Note that for the enzyme reactor column, product concentration, rather than reaction rate, is monitored. Thus, the equation will be valid only under conditions where the initial rate is proportional to product concentration. As noted above, for the present system, conversions of 30% or less lead to errors of 7% or less in estimation of rate data from product concentrations.
Results and Discussion

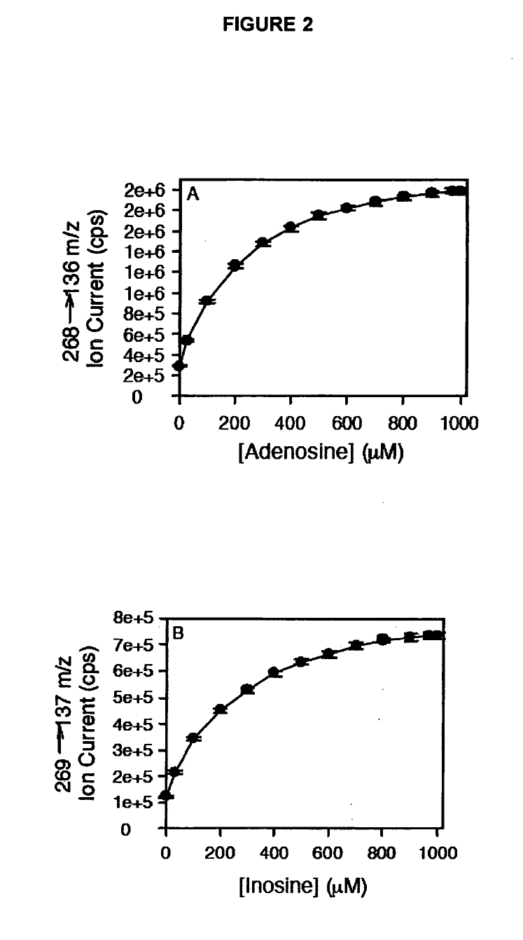

Calibration of MS Signal Intensity: An issue with the use of MS for quantitative detection of species eluting from the reactor column is the potential for ion suppression. Indeed, the signal response was non-linear with respect to the concentration of either adenosine or inosine, as shown in FIG. 2. These data were obtained using 2 mM ammonium acetate buffer with no column present. Higher buffer levels led to increased ion suppression, and thus all remaining experiments were done using the 2 mM buffer system. As noted below, the use of the low ionic strength buffer did not lead to any degradation of entrapped enzyme performance, even over multiple runs of the same column. Optimization of buffer concentration is suggested for each new enzyme studied. Alternatively, the reactor columns could potentially be interfaced to MALDI/MS/MS to help overcome issues with ion suppression and ionic strength limitations.²⁸

Given the non-linear ionization efficiencies seen in FIG. 2, calibratation of the system was done using the ratio of MS signal intensities for product and substrate ions as a function of product:substrate concentration ratio, while infusing a constant total analyte concentration (i.e. constant sum of product+substrate concentrations). Since adenosine is converted to inosine in a 1:1 ratio, the total concentration of these species will be constant regardless of conversion efficiency on column. It should be noted that alternative methods, such as inclusion of an internal standard with similar ionization efficiency to the product ion, could also be used to quantitate the product ion concentration.⁷

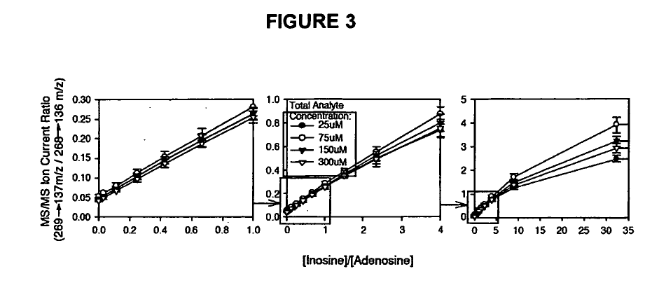

For calibration, solutions containing identical concentrations of adenosine and inosine, in 2 mM ammonium acetate, were mixed and infused into the mass spectrometer to provide a constant total concentration of the two analytes. Various total concentrations of analyte (adenosine+inosine) were tested (25 mM, 75 mM 150 mM and 300 mM). As shown in FIG. 3, the ratio of MS signals for inosine and adenosine are linearly related to the ratios of concentration for the two species over a relatively wide range of ratios (up to about 1.5:1 P:S), indicating that “ion-stealing” does not occur in the range of analyte concentrations tested (25-300 mM). The y-intercept of ˜5% is indicative of signal overlap between inosine and the ¹³C isotope of adenosine, which both have 269→137 as their ion pair for MRM detection. Given that enzyme kinetic studies would generally be done using substrate conversion rates of well under 50%,²⁹ relative enzyme activity can be determined by simply comparing the ratio of signals of product and substrate. However, higher conversion rates, up to a P:S ratio of >10:1 (>90% conversion), can still be quantitated by working with the non-linear portion of the calibration curve. Clearly, the linear range and the curvature of the calibration curve are likely to change for different enzymes with different substrate:product pairs, particularly in cases where ion suppression effects are different for the product and substrate. However, it is expected that this calibration method will be applicable to a range of other enzyme catalyzed reactions.

Knowing the concentration ratio, and noting that the concentration of substrate infused must equal the concentration of substrate plus product eluted: [S]ᵢ=[S]+[P], it is possible to determine the individual concentrations of substrate and product eluted at any time. Since all assays are performed at the same flow rate (10 mL/min), enzyme activity is thus proportional to the concentration of product ([P]) eluted. Prior to performing enzyme inhibition studies, the effect of each compound in the test mixture on the substrate and product signals was assessed by directly infusing compounds into the MS system. In all cases, the inclusion of the test compound at a level of 1 mM, either alone or as a mixture, did not lead to any alteration in the MS signal intensities or in the P/S ratio.

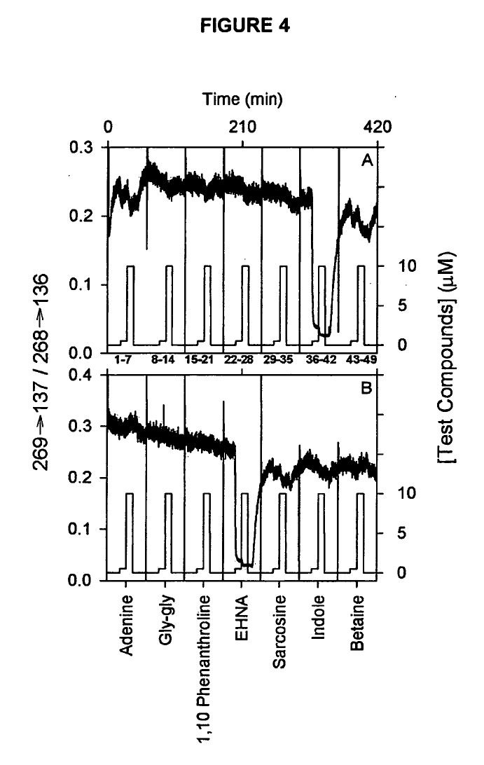

Inhibitor Screening by Enzyme Reactor Chromatography: FIG. 4A demonstrates an automated screen of the 49 compounds listed in Table 2 (seven individual compound mixtures) by enzyme reactor/MS. The infusion profile is shown in the step profile at the bottom of FIG. 4A, while the changes in the P/S ratio are shown across the top of the Figure, indicating ˜40% turnover of substrate in the absence of inhibitor, based on the calibration data in FIG. 3. This provides a large range for alterations in P/S ratios upon introduction of inhibitor, making detection of inhibitors relatively easy. In cases where substrate turnover was inefficient, the P/S ratio may be much smaller, reducing assay sensitivity. In such cases, higher enzyme concentrations or lower flowrates (and hence higher substrate:enzyme contact time) could be used to increase the P/S ratio. Alternatively, the MS parameters could be adjusted to enhance the product signal relative to the substrate signal to increase assay sensitivity. Momentary interruptions in column flow between consecutive injections, executed by the Eksigent pumps, are responsible for the vertical lines seen in the data, which conveniently demarcate each injection. The downward drift in the P/S signal ratio is likely due to the presence of DMSO, given that this ratio was much more consistent in subsequent experiments (see below), where DMSO was absent. This suggests that the ER/MS method is optimally employed with mixtures that do not include DMSO.

Based on the calibration data in FIG. 3 and the starting P/S ratio of ˜0.25, a decrease in P/S signal ratio to ˜0.12 would correspond to substrate turnover dropping from 40% to 20% (50% inhibition). Thus, under the conditions used for the assay, a change in P/S signal ratio to a value of 0.12 is indicative of a compound being present at a concentration equivalent to its IC₅₀ value. Using the two level screen, the inhibition at two concentrations (500 nM and 10 mM) can be evaluated, allowing for semi-quantitative determination of IC₅₀ values of mixtures. As shown in FIG. 4A, only one of the compound mixtures (compounds 36-42) showed a significant alteration in the P/S ratio to a value below 0.12 when present at 500 nM. This is indicative of a compound with an IC₅₀ value well below 500 nM (this is the mixture containing EHNA). On the other hand, none of the other mixtures contained an inhibitor with an IC₅₀ value of less than 10 mM. The most potent inhibitor aside from EHNA was 2-fluoro-2′-deoxyadenosine (K_{I}=17 mM, compound 18), however, this compound would not be expected to have a significant effect on ADA activity in the presence of 200 mM adenosine, as under these conditions the IC₅₀ value would be ˜50 mM. Detection of these weaker inhibitors could be done by using either a lower substrate concentration or a higher inhibitor concentration in the test mixtures.

Several other points should be noted from the data presented in FIG. 4A. Firstly, the overall time for the 49 compound screen is 420 min. This is clearly not “high-throughput”, but in this case serves to demonstrate the principle of the automated screening protocol. Increased throughput could be easily achieved by increasing the mixture complexity. Indeed, Schriemer and co-workers recently reported on the use of a FAC/MS based screening method where a mixture of 1000 compounds was tested by FAC followed by deconvolution of the mixture using a LC/MS approach.¹¹ Analysis time could also be increased by running only a single point screen, reducing equilibration times or by increasing flowrate, although in the present system the Eksigent pumps are limited to a maximum flowrate of 20 mL/min.

A second point is that the system shows excellent recovery after exposure to a potent inhibitor, as demonstrated upon removal of compounds 36-42. In this case, the recovery is slow (30 min), but is essentially complete prior to introduction of the next inhibitor mixture. While not wishing to be limited by theory, the slow recovery is likely the result of the slow off-rate that is typically associated with high affinity inhibitors. More rapid recovery would be expected for lower affinity ligands, and indeed is observed for mixtures that do not contain a potent inhibitor. Importantly, the reversibility of the P/S signal ratio provides clear evidence for the presence of a competitive inhibitor. In cases where irreversible (covalent) inhibitors were present, such recovery would not occur, resulting in loss of column performance. This is a problem any screening method that utilizes immobilized enzymes (i.e., FAC/MS), and thus is not unique to the present approach.

A final point is that the data show that the column remains active over a period of many hours, showing the utility of the sol-gel columns for development of immobilized enzyme reactors. This is particularly important given that some proteins, such as dihydrofolate reductase, do not survive the low ionic strength conditions required for ESI/MS detection.²⁵

While FIG. 4A shows the presence of an active mixture, it does not provide insight into the identity of the active compound. FIG. 4B shows one method for identification of the active compound by testing of the individual compounds present in the active mixture, and reveals EHNA to be the active, inhibitory compound (note: this assay was performed with the same column used for the primary screen). This method has the advantage that the determination of the inhibitory compound is based on changes in activity rather than simple binding, minimizing issues such as non-selective binding of test compounds to the column matrix. This method should be suitable in cases where mixtures are not highly complex, and where the identity of the compounds in the mixture is known. For more complex mixtures, or in cases where compound identity is not known, alternative deconvolution methods may be used. These might include secondary analysis of mixtures by FAC/MS,^{10,11,12} additional fractionation and retesting by ER/MS, pre-fractionation of mixtures by reversed-phase LC prior to ER/MS, or use of an bioselective extraction method using an enzyme-doped column to select high affinity compounds from the active mixture,³⁰ followed by testing by ER/MS.

Quantitative Binding Analysis by Enzyme Reactor Chromatography:

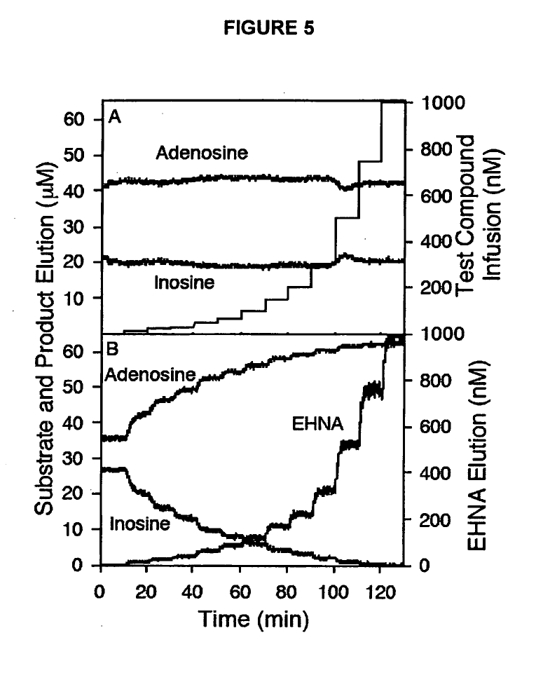

To validate that quantitative inhibition data could be obtained by ER/MS, the response of P/S ratios as a function of inhibitor concentration was evaluated. FIG. 5 shows data obtained by injecting many different concentrations of test compounds onto ADA columns. DMSO was not present in these test mixtures to avoid drift in the MS signal with time. Removal of DMSO is also likely to provide more physiologically relevant ligand binding data. In this experiment, adenosine was infused at a constant concentration of 62.5 mM while the concentration of test compounds was increased from 0 mM to 1 mM over the course of the experiment. As shown in Panel A, a mixture of non-inhibitors, including fluorescein, folic acid and pyrimethamine, had no significant effect on substrate or product signals, indicating that the activity of ADA was not altered by these compounds. However, when EHNA was added to the mixture (Panel B) a concentration-dependent decrease in product and increase in substrate signals, corresponding to a decrease in ADA activity, is apparent. The stepwise inhibition seen in FIG. 5b demonstrates the potential for enzyme reactor chromatography/MS to obtain quantitative binding data from high-resolution, primary mixture screens such as the screen shown in FIG. 4a. It should be noted that while this assay required approximately 2 h to complete, most of this time was used to ensure equilibration of the system. Assay time could be reduced significantly by either reducing the number of points or by using shorter equilibration times.

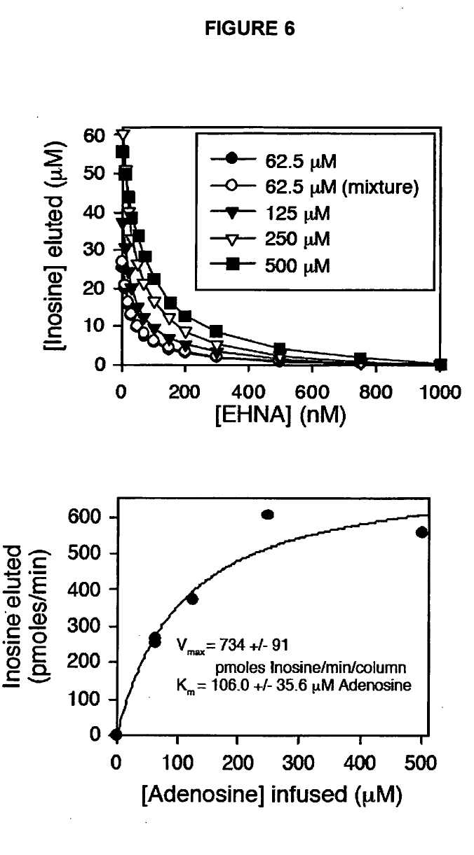

FIG. 6a shows inhibitor saturation curves as a function of substrate concentration obtained from the data shown in FIG. 5 and subsequent experiments on the same column, at different substrate concentrations. The different product concentrations seen for each adenosine concentration are expected because slower reaction rates are predicted at lower substrate concentrations. The percent substrate conversion in the absence of inhibitor was as follows: 62.5 mM=42%; 125 mM=29%; 250 mM=24%; 500 mM=11%. It is assumed that the initial reaction rate is proportional to product concentration when using endpoint assays to determine kinetic parameters. In general, this only holds up to substrate conversion rates of ca 10%,²⁹ but this depends on the specific concentration of substrate relative to the Kₘ value. Given the accepted Kₘ value of 100 mM for the conversion of adenosine by ADA, the substrate concentrations in FIG. 6a correspond to 0.625 Kₘ, 1.25 Kₘ, 2.5 Kₘ and 5.0 Kₘ. The largest percentage of substrate conversion occurred at 62.5 mM adenosine (0.625 Kₘ), with 42% conversion. The concentration of substrate drops from 0.625 Kₘ to ˜0.36 Kₘ over the course of the chromatographic run, with the average substrate concentration during the experiment being ˜0.49 Kₘ. Operating at 0.625 Kₘ, it is expected to have a rate of reaction of 38.5% of Vₘₐₓ (recall that at [S]=Kₘ, the rate is ½ Vₘₐₓ). When operating at 0.49 Kₘ, the rate will be 33.1% of Vₘₐₓ, corresponding to 85% of the expected rate. Thus, using product concentration directly leads to an underestimation of initial rate by ca. 15%. Applying the same analysis to the other substrate concentrations, underestimations of ca. 7% at 125 mM, 4% at 250 mM and 1% at 500 mM are obtained. It should be noted that by using the continuous flow method, it is possible to adjust flow rate and column length to suit more or less active enzymes so that conversion rates are in the range where product concentration is proportional to initial rate.

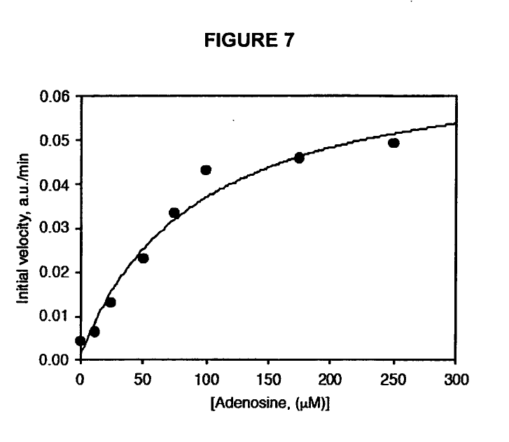

FIG. 6b shows the rate of inosine production (pmoles/min/column) as a function of the concentration of infused adenosine concentration, obtained by multiplying the concentration of inosine eluting from the column at each substrate concentration (from FIG. 6a) by the column flowrate. The data show the saturation profile expected for enzyme catalyzed reactions. Michaelis-Menten analysis of the curve provided a Vₘₐₓ of 734 pmole/min/column and a Kₘ value of 106 mM of adenosine. The relative errors on these numbers are fairly high (up to 30% RSD) owing to the effects of ion suppression, which made it difficult to obtain points at higher adenosine concentrations, and due to the assumption that product concentration related directly to initial rates, which does not hold at lower substrate concentrations. Indeed, as shown in FIG. 6b, the point at 500 mM adenosine lies below that obtained at 250 mM adenosine. Even so, the Kₘ value obtained is in good agreement with the Kₘ value obtained for the soluble form of the enzyme using an absorbance-based assay (89 mM, FIG. 7),⁸ showing that the entrapped enzyme retains binding affinity for the substrate that is similar to that observed in solution. The consistency and resemblance of this data to that obtained by UV absorbance and published data is even more impressive when one realizes that the points shown in FIG. 6b were all obtained using the same column. Indeed, these data are only 5 amongst 60 enzyme activity measurement done using the same immobilized enzyme column.

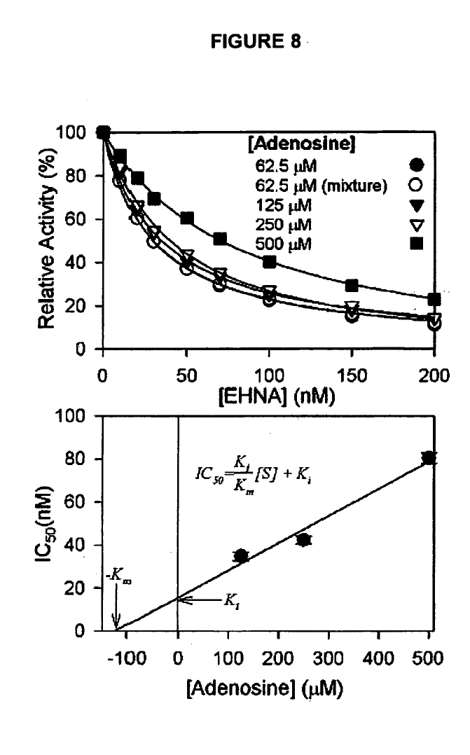

FIG. 8 shows how changes in enzyme activity as a function of inhibitor concentration can be used to determine IC₅₀ and Kᵢ values. Panel A is similar to FIG. 6a, except that it is normalized to show the 50% inhibition point more clearly. Fitting to a simple ligand binding isotherm provides IC₅₀ values (top panel). The nearly identical IC₅₀ values obtained for EHNA in a mixture (29.7 nM, open circles) and alone (29.4 nM, closed circles) indicate the usefulness and validity of this technique for quantitative measurements by mixture screening. A novel form Cheng and Prusoff's equation²⁶ allows extrapolation of the IC₅₀ values to provide the K_{I} [EHNA] and Kₘ for the substrate, as shown in FIG. 8b. It should be noted that the point at 62.5 mM adenosine was not used in the determination of K_{I} and Kₘ values, as this substrate concentration did not allow for the assumption of initial rate being proportional to product concentration, as noted above. The resulting K_{I} of 15.7±3.5 nM is in reasonable agreement with the published K_{I} value of 6.5 nM.³¹ The Kₘ value of 124±42 mM also matches with values obtained from absorbance assays (89 mM)²⁷ and enzyme reactor/MS assays (106 mM). Hence, the use of the immobilized enzyme reactor column provides kinetic and inhibition data that are of sufficient accuracy to allow the method to be used for both primary screening and quantitative analysis of enzyme inhibition.

### Example 2

### Factor Xa Enzyme Reactor/MS

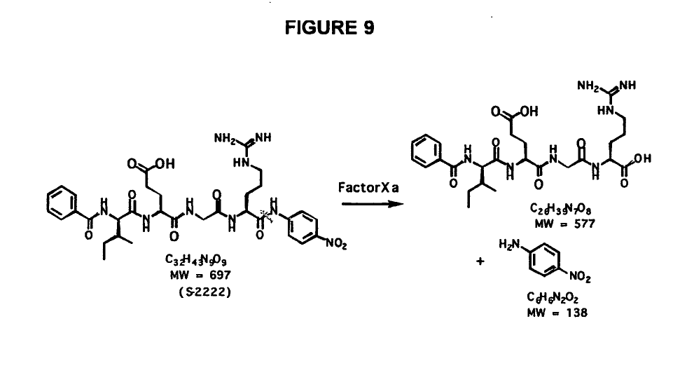

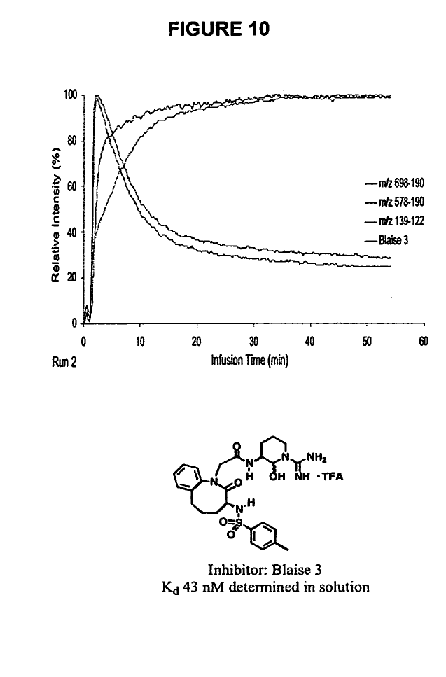

Determination of Factor Xa activity on-column utilized a syringe pump operated at 5 μL/min flowrates with buffer in one channel (Channel A) and buffer+substrate+inhibitor in the other channel (Channel B). FIG. 9 shows the reaction that is catalyzed by Factor Xa The chromogenic substrate S-2222 (m/z 697) is cleaved by Factor Xa into a tripeptide with a m/z value of 577 and p-nitroanaline, with a m/z value of 136. Both the substrate and product can be monitored in real time by mass spectrometry, as shown in FIG. 10. As shown in Table 3, when there is no inhibitor present in Channel B, the addition of substrate (1000 μM) to a blank column results in minimal substrate conversion, while addition to a column containing FXa results in significant production of the products and a corresponding decrease in the substrate signal. This is indicative of substrate turnover by the enzyme in the column.

Addition of increasing concentrations of inhibitor to Channel B (with 1000 μM substrate) leads to a concentration-dependent decrease in product concentration eluting from the column, as shown in Table 4. Note that the data were obtained from three separate experiments—in this mode of operation is it not possible to alter inhibitor concentration on-line. The data clearly show that the inhibitor is able to block substrate turnover, even at levels of 0.1 μM. While it is not possible to extract IC₅₀ or K_{I} values from the present data, the data are consistent with inhibitor having an IC₅₀ value of less than 100 nM, as expected based on the known K_{I} value of the compound (43 nM).

While the present invention has been described with reference to the above examples, it is to be understood that the invention is not limited to the disclosed examples. To the contrary, the invention is intended to cover various modifications and equivalent arrangements included within the spirit and scope of the appended claims.

All publications, patents and patent applications are herein incorporated by reference in their entirety to the same extent as if each individual publication, patent or patent application was specifically and individually indicated to be incorporated by reference in its entirety. Where a term in the present application is found to be defined differently in a document incorporated herein by reference, the definition provided herein is to serve as the definition for the term.

TABLE 1

| | Q1 | Q3 | Time | DP | EP | CE | CXP |
|---|---|---|---|---|---|---|---|
| Species | (m/z) | (m/z) | (ms) | (V) | (V) | (V) | (V) |
| Adenosine | 268 | 136 | 495 | 66 | 6.8 | 29.4 | 3.3 |
| Inosine | 269 | 137 | 495 | 49 | 4.0 | 22.0 | 4.0 |
| EHNA* | 278 | 119 | 495 | 90 | 10.0 | 52.0 | 4.0 |
| EHNA | 278 | 136 | 495 | 90 | 10.0 | 52.0 | 4.0 |

*Note:
The weaker signal from this EHNA ion-pair was not used for data analysis but it's presence in the MRM method leads to a total scan time of 2 seconds, including 20 msec pause.

TABLE 2
Compounds Tested:

| # | Name |
|---|---|
| 1 | (−)-Sulpiride |
| 2 | (−)-Butaclamol.HCl |
| 3 | Haloperidol |
| 4 | 4-Nitrophenethyl bromide |
| 5 | Spiperone |
| 6 | L-glutamicacid-γ-(p-nitroanilide).HCl |
| 7 | Dipyridamol |
| 8 | ATP |
| 9 | Glybenclamide |
| 10 | Glipizide |
| 11 | Benzamidine.HCl |
| 12 | Dextromethorphan.HBr |
| 13 | Pyrimethamine |
| 14 | N-Acetyl-L-Tryptophanamide |
| 15 | Trimethoprim |
| 16 | XTT.Na |
| 17 | Deoxycholic acid |
| 18 | 2-Fluoro-2′-deoxyadenosine |
| 19 | Carbamylcholine.Cl |
| 20 | Chloropromazine.HCl |
| 21 | Acetopromazine.maleate |
| 22 | Nα-Benzoyl-DL-Arginine-p-nitroanalide |
| 23 | p-nitrophenyl butyrate |
| 24 | 7-chloro-4-nitrobenz-2-oxa-1,3-diazole |
| 25 | N-benzoyl-L-Tyrosine ethyl ester |
| 26 | Acetaminophen |
| 27 | Caffeine |
| 28 | 7-Azaindole |
| 29 | Cytidine 2′:3′-cyclic monophosphate.Na |
| 30 | Nε-Acetyl-L-lysine |
| 31 | Acetylcholine.Cl |
| 32 | (+)-Tubocurarine.Cl |
| 33 | Uridine 5′-diphospho-n-acetyl glucosamine |
| 34 | Phospho(enol)pyruvate.K |
| 35 | (−)-Nicotine.H-tartarate |
| 36 | Adenine |
| 37 | Gly-gly |
| 38 | 1,10-phenanthroline |
| 39 | EHNA |
| 40 | Sarcosine |
| 41 | Indole |
| 42 | Betaine |
| 43 | Trifluoperazine dihydrochloride |
| 44 | Activicin |
| 45 | p-nitrophenyl acetate |
| 46 | Guanylyl(2′-5′)cytidine.NH₄ |
| 47 | Acetylthiocholine.Cl |
| 48 | DL-Azatryptophan |
| 49 | +/−Epibatidine.2HCl |

TABLE 3
Plateau values for substrate and inhibitor signals
obtained for flow of 1 mM of S2222 substrate into
a column at a flowrate of 5 μL/min.

| | |
|---|---|
| No Protein | 26 pmol FXa on column |

| | | | |
|---|---|---|---|
| Substrate | 36,818 | cps | 8,236 cps |
| Product 1 | 83 | cps | 12,200 |
| Product 2 | 142 | cps | 11,727 |

TABLE 4
Effect of inhibitor concentration on substrate
and product plateau signals (cps).

| Cmpd. | 0 μM | 0.1 μM | 1.0 μM |
|---|---|---|---|
| Substrate | 8,236 | 19,037 | 23,312 |
| Product 1 | 12,200 | 4,040 | 1,860 |
| Product 2 | 11,727 | 4,310 | 2,161 |

### FULL CITATIONS FOR DOCUMENTS IN THE SPECIFICATION

¹. Houston, J. G.; Banks, M. The chemical-biological interface: developments in automated and miniaturised screening technology. Curr. Opin. Biotechnol. 1997, 8, 734-740.
². Burns, K. L., May, S. W. J. Chromatogr. B, 2003, 797, 175-190.
³. a) Wu, J.; Takayama, S.; Wong, C.-H.; Siuzdak, G. Chem. Biol. 1997,4,653-657; b) Bothner, B.; Chavez, R; Wei, J.; Strupp, C.; Phung, Q.; Schneemann, A.; Siuzdak, G. J. Biol. Chem. 2000, 275, 13455-13459; c) Shen, Z.; Go. E. P.; Gamez, A.; Apon, J. V.; Fokin, V.; Greig, M.; Ventura, M.; Crowell, J. E.; Blixt, O.; Paulson, J. C.; Stevens, R. C.; Finn, M. G., Siuzdak, G. ChemBioChem 2004, 5, 921-927.
⁴. a) Lee, E. D.; Mück, W.; Henion, J. D.; Covey, T. R. J. Am. Chem. Soc. 1989, 111, 4600-4604; b) Benetton, S.; Kameoka, J.; Tan, A.; Wachs, T.; Craighead, H.; Henion, J. D. Anal. Chem. 2003, 75, 6430-6436.
⁵. Lei, Q. P.; Lamb, D. H.; Heller, R. K.; Shannon, A. G.; Ryall, R; Cash, P. Anal. Biochem. 2002, 310, 122-124
⁶. Newton, R. P.; Bayliss, M. A.; Khan, J. A.; Bastani, A.; Wilkins, A. C. R; Games, D. E.; Walton, T. J.; Brenton, A. G.; Harris, F. M. Rapid Commun. Mass Spectrom. 1999, 13, 574-584.
⁷. a) Ge, X.; Sirich, T. L.; Beyer, M. K; Desaire, H.; Leary, J. A. Anal. Chem. 2001, 73, 5078-5082; b) Pi, N.; Armstrong, J. I.; Bertozzi, C. R.; Leary, J. A. Biochemistry 2002, 41, 13283-13288; c) Pi, N.; Yu, Y.; Mougous, J. D.; Leary, J. A. Protein Science 2004, 13, 903-912; d) Pi, N.; Freel Meyers, C. L.; Pacholec, M.; Walsh, C. T.; Leary, J. A. Proc. Natl. Acad. Sci. 2004, 101, 10036-10041.
⁸. a) Min, D.-H.; Tan, W.-J.; Mrksich, M. Nature Biotech 2004, 22, 717-723; b) Min, D.-H.; Su, J.; Mrksich, M. Angew. Chem. Int. Ed 2004, 43, 5973-5977; c) Min. D.-H., Yeo, W.-S.; Mrksich, M. Anal. Chem. 2004, 76, 3923-3929.
⁹. de Boer, A. R.; Letzel, T.; van Elswijk, D. A.; Lingeman, H.; Niessen, w. M. A.; Irth, H. Anal. Chem. 2004, 76, 3155-3161.
¹⁰. Schriemer, D. C. Biosensor alternative: frontal affinity chromatography. Anal. Chem. 2004, 76, 440A.
¹¹. Ng, E. S. M.; Yang, F.; Kameyama, A.; Palcic, M. M.; Hingsgaul, O.; Schreimer, D. C. Anal. Chem 2005, asap article 10.1201/ac051131r.
¹². Zhang, B.; Palcic, M. M.; Schriemer, D. C.; Alvarez-Manilla, G.; Pierce, M.; Hindsgaul, O. Frontal Affinity Chromatography Coupled to Mass Spectrometry for Screening Mixtures of Enzyme Inhibitors. Anal. Biochem. 2001, 199, 173.
¹³. a) Bartolini, M.; Andrisano, V.; Wainer, I. W. J. Chromatog. A 2003, 987, 331-340. b) Markoglou, N.; Hsuesh, R.; Wainer, I. W. J. Chromatog B 2004, 804, 295-302.
¹⁴. Massolini, G.; Calleri, E.; Lavecchia, A.; Loiodice, F.; Lubda, D.; Temporini, C.; Fracchiolla, G.; Tortorella, P.; Novellino, E.; Caccialanza, G. Anal. Chem. 2003, 75, 535-542.
¹⁵. Palm, A. K.; Novotny, M. V. Rapid Commun. Mass Spec. 2005, 19, 1730-1738.
¹⁶. Zhang, B.; Palcic, M. M.; Schriemer, D. C.; Alvarez-Manilla, G.; Pierce, M.; Hindsgaul, O. Anal. Biochem. 2001, 199, 173-182.
¹⁷. a) Bartolini, M.; Andrisano, V.; Wainer, I. W. Development and characterization of an immobilized enzyme reactor based on glyceraldehyde-3-phosphate dehydrogenase for on-line enzymatic studies. J. Chromatog. A 2003, 987, 331. b) Markoglou, N.; Hsuesh, R.; Wainer, I. W. Immobilized enzyme reactors based upon the flavoenzymes monoamine oxidase A and B. J. Chromatog B 2004, 804, 295.
¹⁸. Covey, T.; Kovarik, P. “Method and Apparatus for Sample Deposition”, U.S. patent application Ser. No. 11/349,337 filed Feb. 8, 2006 and PCT Patent Application No. PCT/CA2006/000168, filed Feb. 8, 2006.
¹⁹. Morgan, G.; Levinsky, R. J.; Hugh-Jones, K.; Fairbanks, L. D.; Morris, G. S.; Simmonds, H. A. Clin. Exper. Immunol. 1987, 70, 491-499.
²⁰. Cheng, Y.-C.; Prusoff, W. H. Relation between the inhibition constant K1) and the concentration of inhibitor which causes fifty percent inhibition (I50) of an enzymic reaction Biochem. Pharmacol 1973, 22, 3099.
²¹. Agarwal R. P. Inhibitors of adenosine deaminase. Pharmac. Ther. 1982, 17, 399.
²². Gabellieri, E.; Bernini, S.; Piras, L.; Cioni, P.; Balestreri, E.; Cercignani, G.; Felicioli, R Purification, stability and kinetic properties of highly purified adenosine deaminase from Bacillus cereus NCIB 8122. Biochim. Biophys. Acta 1986, 884, 490.
²³. Jacomelli, G.; Micheli, V.; Peruzi, L.; Notarantonio, L.; Cerboni, B.; Sestini, S.; Pompucci, G. Simple non-radiochemical HPLC-linked method for screening for purine metabolism disorders using dried blood spot. Clinica Chimica Acta 2002, 324, 135-139.
²⁴. Brook, M. A.; Chen, Y.; Guo, K.; Zhang, Z.; Brennan, J. D. J. Mater. Chem. 2004, 14, 1469-1479.
²⁵ Hodgson, R. J.; Chen, Y.; Zhang, Z.; Tleugabulova, D.; Long, H.; Zhao, X.; Organ, M. G.; Brook, M. A.; Brennan, J. D. Anal. Chem. 2004, 76, 2780-2790.
²⁶. Cheng, Y.-C.; Prusoff, W. H. Biochem. Pharmacol 1973, 22, 3099-3108.
²⁷. E. Gabellieri, S. Bernini, L. Piras, P. Cioni, E. Balestreri, G. Cercignani, R. Felicioli, Biochim. Biophys. Acta 1986, 884, 490-496.
²⁸. Kovarik, P.; Hodgson, R. J.; Covey, T. R.; Brook, M. A.; Brennan, J. D. Anal. Chem. 2005, 77, 3340-3350.
²⁹. Cornish-Bowden, A. Fundamentals of Enzyme Kinetics, Third Edition; Portland Press Ltd, London, UK, 2004.
³⁰. Kelly, M. A.; Liang, H.; Sytwu, I.-I.; Vlattas, I.; Lyons, N. L.; Bowen, B. R.; Wennogle, L. P. Biochemistry, 1996, 35, 11747-11755.
³¹. Agarwal, R. P. Pharmac. Ther. 1982, 17, 399-429.

We claim:

1. A method for screening for modulators of a protein comprising:
(a) contacting a stream comprising a substrate for the protein with a monolithic chromatographic stationary phase comprising the protein immobilized therein under conditions for the substrate to react with the protein to produce a product;
(b) introducing into said stream one or more test compounds; and
(c) observing a change in the ratio of product concentration to substrate concentration (P/S) directly or via an indicator of product concentration and an indicator of substrate concentration, in the presence of the one or more test compounds,
wherein a change in P/S in the presence of the one or more test compounds compared to in the absence of the one or more test compounds indicates that at least one of the one or more test compounds is a modulator of the protein.

2. The method according to claim 1, wherein if the P/S ratio is altered in favour of the substrate, then at least one of the one or more test compounds is an inhibitor of the protein.

3. The method according to claim 2, wherein an IC₅₀ for the one or more test compounds is obtained by determining a concentration of the one or more test compounds at the point where the product concentration decreases to 50% of its value in the absence of the one or more test compounds.

4. The method according to claim 3, further comprising determining a K_{I} value for the one or more test compounds by extrapolation of the IC₅₀ values for the one or more compounds obtained at different substrate concentrations to a point of zero substrate concentration.

5. The method according to claim 1, further comprising washing the column under conditions to remove unbound, or loosely bound compounds, followed by a second wash under conditions to remove the modulator, said modulator then being introduced directly into a mass spectrometer for structural characterization.

6. The method according to claim 1, wherein the indicator of product and substrate concentration is an intensity of a characteristic molecular ion signal obtained from a mass spectrometer directly interfaced with the monolithic chromatographic stationary phase.

7. The method according to claim 6, wherein the mass spectrometer is operated in positive ion or negative ion electrospray ionization (ESI) mode.

8. The method according to claim 7, wherein mass spectral detection is carried out in multiple reaction monitoring mode.

9. The method according to claim 6, mass spectrometer is operated in MALDI MS/MS mode.

10. The method according to claim 1 wherein the monolithic chromatographic column contains a single immobilized enzyme.

11. The method according to claim 1, wherein the monolithic chromatographic column contains multiple enzymes.

12. The method according to claim 11, wherein the enzymes are part of a metabolic pathway or part of a multi-enzyme complex.

13. The method according to claim 11, wherein observation of changes in specific P/S ratios for a particular enzyme on-column are made.

14. The method according to claim 1, wherein the protein is a cytochrome P450 and the method is used for toxicity screening to assess metabolism of potential substrates or inhibition of substrate turnover using MS to assess substrate to product conversion.

15. The method according to claim 5, wherein the one or more compounds are a combinatorial library.
